(19) United States
(12) Patent Application Publication
(10) Pub. No.: US 2017/0344934 A1
(43) Pub. Date: Nov. 30, 2017

(54) SYSTEMS AND METHODS FOR MONITORING THE CONDITION OF MERCHANDISE LOADED ON A DELIVERY VEHICLE

(71) Applicant: Wal-Mart Stores, Inc., Bentonville, AR (US)

(72) Inventors: Andrew B. Millhouse, Gilbert, AZ (US); Timothy J. Burleson, Bentonville, AR (US); John S. Meredith, Bentonville, AR (US)

(21) Appl. No.: 15/593,821

(22) Filed: May 12, 2017

Related U.S. Application Data
(60) Provisional application No. 62/337,035, filed on May 16, 2016.
(60) Provisional application No. 62/412,678, filed on Oct. 25, 2016.

(51) Int. Cl. G06Q 10/08; G06Q 10/10; G06Q 50/28; G06Q 50/30

(52) U.S. Cl. CPC G06Q 10/083; G06Q 50/30; G06Q 10/10; G06Q 50/28

(57) ABSTRACT

In some embodiments, apparatuses and methods are provided herein useful to monitoring the loading conditions of merchandise in a delivery vehicle. In some embodiments, there is provided a system for monitoring load quality of merchandise delivered to shopping facilities, the system including: a delivery location at a shopping facility configured to receive a delivery vehicle; a mobile device configured to: input identification information regarding delivered merchandise transported in the delivery vehicle; input a description of how delivered merchandise is loaded and arranged in the interior of the delivery vehicle; capture and input an image of the interior of the delivery vehicle showing loading and arrangement of merchandise; a control circuit operatively coupled to the mobile device and configured to transmit the identification information, description, and image; and a database configured to receive and store the identification information, description, and image from the control circuit.

### CROSS-REFERENCE TO RELATED APPLICATIONS

This application claims the benefit of U.S. Provisional Application No. 62/337,035, filed May 16, 2016, and U.S. Provisional Application No. 62/412,678, filed Oct. 25, 2016, which are incorporated herein by reference in their entirety.

### TECHNICAL FIELD

This invention relates generally to monitoring the loading conditions of merchandise, and more particularly, to monitoring the loading conditions of merchandise arranged in an arriving delivery vehicle.

### BACKGROUND

In the retail setting, one important aspect is the delivery of merchandise to shopping facilities, which may be sold to customers. More specifically, if merchandise is not loaded properly on the delivery vehicles that are delivering the merchandise to shopping facilities, the merchandise may be damaged and may not be in a sellable condition. Further, with regard to certain types of merchandise (such as perishable items), there may be certain loading conditions that should be met in order to maintain the freshness and quality of the merchandise.

Accordingly, it is desirable to be able the monitor the loading conditions and load quality of the merchandise that is delivered on delivery vehicles. It is desirable to capture various types of information and detail regarding the loading conditions on delivery vehicles and provide real-time feedback of these conditions. Further, it is desirable to communicate this feedback to the destination shopping facility, the source distribution center, and/or the delivery vehicles in order to improve the loading of merchandise for future deliveries.

### BRIEF DESCRIPTION OF THE DRAWINGS

Disclosed herein are embodiments of systems, apparatuses and methods pertaining to monitoring the loading conditions of merchandise in a delivery vehicle. This description includes drawings, wherein:

FIG. 1 is a flow diagram in accordance with some embodiments;

FIG. 2 is a block diagram in accordance with several embodiments;

FIG. 3 is a block diagram in accordance with some embodiments;

FIG. 4 is a flow diagram in accordance with several embodiments;

FIGS. 5-12 are screenshots in accordance with some embodiments;

FIG. 13 is a block diagram in accordance with some embodiments; and

FIG. 14 is a flow diagram in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for monitoring the merchandise load conditions in an arriving delivery vehicle. In some embodiments, there is provided a system for monitoring load quality of merchandise delivered to shopping facilities, the system including: a delivery location at a shopping facility configured to receive a delivery vehicle; a mobile device configured to: input identification information regarding delivered merchandise transported in the delivery vehicle; input a description of how delivered merchandise is loaded and arranged in the interior of the delivery vehicle; capture and input an image of the interior of the delivery vehicle showing loading and arrangement of merchandise; a control circuit operatively coupled to the mobile device and configured to transmit the identification information, description, and image; and a database configured to receive and store the identification information, description, and image from the control circuit.

In one form, the identification information may include at least one of shopping facility identification, shipping source identification, route information, delivery vehicle identification, type of merchandise, and date of delivery. Further, the description may include at least one of information regarding load stacking, load packing, arrangement and location of the load in the delivery vehicle, pallet information, damage to the load, and temperature information. Also, the capture of an image may include using a camera to take a picture or video of the interior of the delivery vehicle. Moreover, the image may convey information regarding how the merchandise was loaded, transported, or found at the delivery location after delivery.

In one form, the identification information, description, and image may be inputted at the delivery vehicle when the delivery vehicle arrives at the delivery location. Further, the mobile device may be in wireless communication with a website server configured to serve as a platform for the input of the identification information, description, and image and to allow storage to the database coupled to the website server. Also, the merchandise may be delivered to the delivery location from a distribution center. Moreover, the mobile device may include one or more of a smartphone, a computer tablet, and a portable computer.

In some embodiments, there is provided a method for monitoring load quality of merchandise delivered to shopping facilities, the method including: by a mobile device, inputting identification information regarding delivered merchandise transported in a delivery vehicle to a shopping facility; by a mobile device, inputting a description of how delivered merchandise is loaded and arranged in the interior of the delivery vehicle; and by a mobile device, capturing and inputting an image of the interior of the delivery vehicle showing loading and arrangement of merchandise.

In one form, the method may include transmitting feedback information regarding the description and image to a merchandise distribution center that shipped the merchandise to the shopping facility. In addition, the method may include transmitting feedback information regarding the description and image to a manager at the shopping facility. Further, the method may delivering the merchandise from a merchandise distribution center to a delivery location receiving the delivery vehicle at the shopping facility.

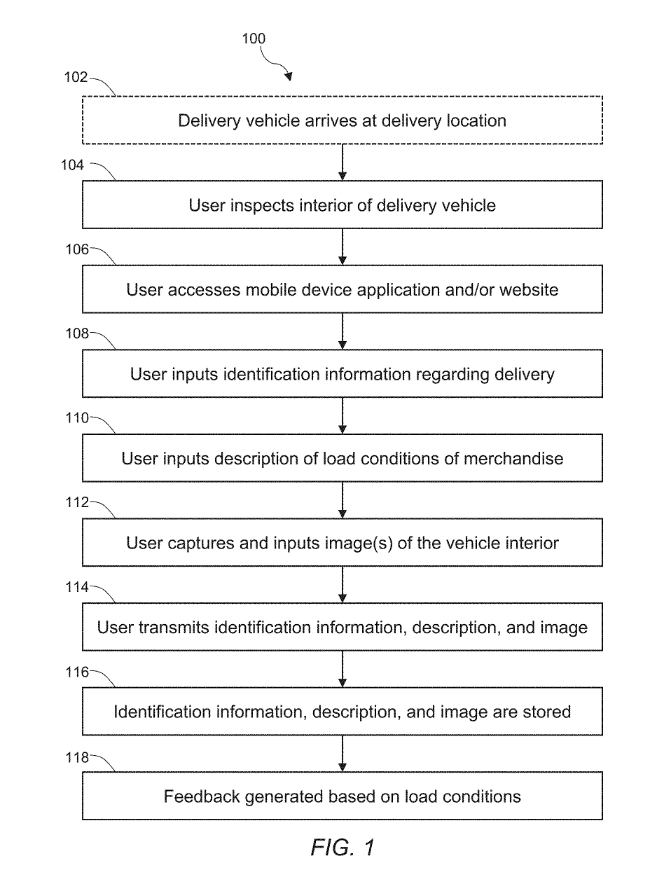

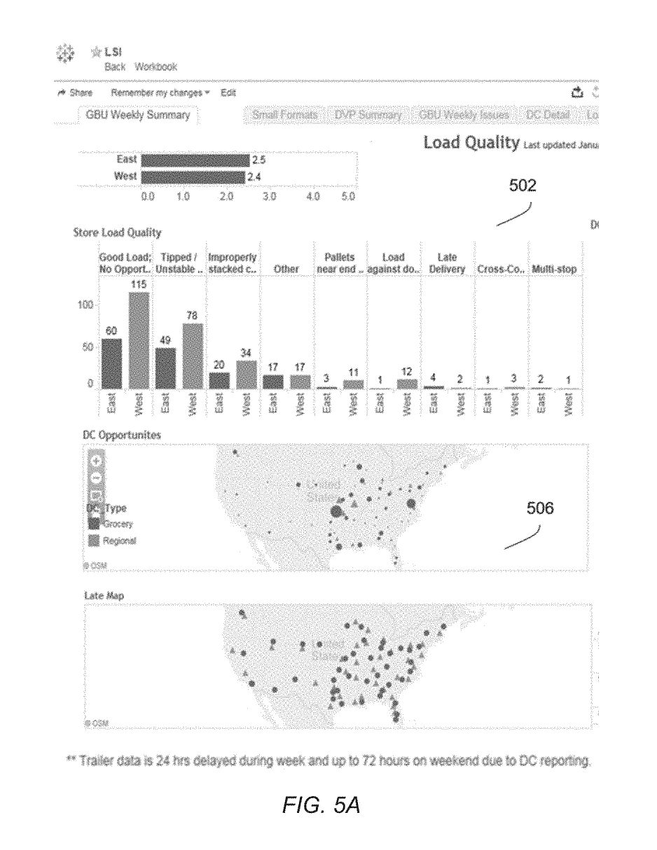

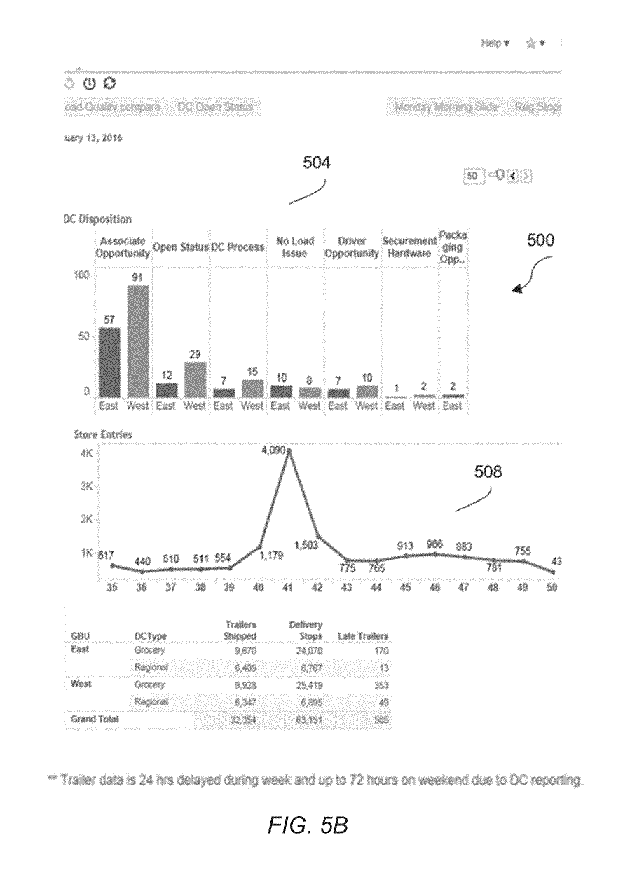

This disclosure generally addresses two aspects of the invention: (1) generating individual load condition/quality reports that describe and show load conditions/quality for an individual delivery of merchandise by a delivery vehicle to a shopping facility; and (2) analyzing and aggregating these individual load quality reports to determine particular load quality conditions that may be prevalent for specific delivery vehicles or routes, specific shopping facilities, or specific geographical areas. FIGS. 1-4 show the first aspect relating to generating an individual load quality report. FIGS. 5-14 show the second aspect relating to using numerous load quality reports to determine issues for specific delivery vehicles/routes, specific shopping facilities, and specific geographical areas.

Referring to FIG. 1, there is shown a process 100 for monitoring the loading conditions of a delivery vehicle arriving at a shopping facility. In one form, the process 100 seeks to provide a low-cost approach in which some description and image(s) of the interior of the delivery vehicle are generated when the delivery vehicle arrives at the shopping facility and prior to unloading of the merchandise. This approach allows users to submit real-time feedback of load conditions on mobile devices through forms and images. This information can then be communicated to various individuals and groups within the distribution chain to provide feedback about the loading conditions and to allow them to be improved for future deliveries.

At block 102, a delivery vehicle is shown as arriving at a delivery location. In one form, it is contemplate that the delivery vehicle (truck, etc.) will deliver merchandise from a distribution center and will arrive at a loading dock of a shopping facility, or a comparable delivery location at a shopping facility configured to receive a delivery vehicle, where merchandise can be unloaded and moved into the shopping facility. This action is not necessarily part of the process but is shown to give context to the other blocks shown in FIG. 1. Further, as should be understood in this disclosure, some of the steps in the flow diagrams are optional and are not required in some processes, and some of the steps may be performed in different sequences in some processes.

At block 104, after arrival of the delivery vehicle, a user inspects the loading conditions of the merchandise in the interior of the delivery vehicle. It is generally contemplated that the user will have a mobile device (such as a smartphone, MC40 handheld device, computer tablet, or other portable computing device) that will enable him to collect and input information regarding the loading conditions. This action preferably occurs prior to unloading of the merchandise, which may alter some of the loading conditions.

At block 106, the user may use the mobile device to access a mobile device application and/or a website. In one form, it is contemplated that the user may access some downloaded software application or program for inputting the information regarding load conditions. In one form, it is contemplated that the user may be in wireless communication with a website server configured to serve as a platform for the input of the information and to allow storage of the information on a database coupled to the website server. This action may occur at any of various points in the process 100, and, for example, the user may be in wireless communication with the website prior to inspecting the interior of the delivery vehicle. In another form, it is contemplated that the user may input the information regarding load conditions into a database on the mobile device without accessing a mobile device application and/or a website.

At block 108, the user inputs identification information regarding the delivery via the mobile device. In one form, as mentioned above, it is contemplated that the user is in wireless communication with a website. In this form, the website may include a customized form in which various fields may be populated and/or drop down menus may be used to input data points/information. The identification information may be used to identify the delivered merchandise transported in the delivery vehicle. For example, the identification information may include destination shopping facility identification, shipping source identification, route information, delivery vehicle identification, the type of merchandise, and/or date of delivery. Further, some or all of this identification information may be typed into specific fields and/or be selected from entries in drop down menus.

At block 110, the user inputs a description of the load conditions of the merchandise in the delivery vehicle via the mobile device. More specifically, the user inputs a description of how the delivered merchandise is loaded and arranged in the interior of the delivery vehicle. In one form, involving a customized form on a website, the user may input and describe load stacking, load packing, arrangement and location of the load in the delivery vehicle, pallet information, damage to the load, and temperature information. Again, in one form, some or all of this load quality description may be typed into specific fields and/or selected from drop down menus.

At block 112, the user captures and inputs one or more images of the interior of the delivery vehicle. It is generally contemplated that the mobile device will include a camera or other optical device in which to capture images, which may be still images or video. Of course, the user may also utilize a camera or optical device that is completely separate from and not integrated into the mobile device. As such, with respect to process 100, it is contemplated that the user may utilize a single mobile to input the identification information, load condition description, and images, but it is also contemplated that the user may use multiple mobile devices (i.e., a smartphone to input the identification information and load condition description and a separate camera to capture images).

The user captures and inputs image(s) of the interior of the delivery vehicle showing the loading and arrangement of the merchandise therein. These image(s) serve as a second source of information regarding loading conditions (in addition to the description described above). The image(s) convey information regarding how the merchandise was loaded, transported, or found at the delivery location after delivery. In one form, involving a customized form on a website, it is contemplated that the image(s) are wirelessly transmitted by the mobile device to the website. The website may prompt attachment of the image(s).

At block 114, the user transmits the identification information, description, and image. As addressed above, in one form, it is contemplated that the user transmits this information wirelessly from a mobile device to a server website. More specifically, a control circuit is operatively coupled to the mobile device and configured to transmit the identification information, description, and image(s). As should be evident, this information may be transmitted in any of various ways and at various stages of process 100. In one form, it is contemplated that the information will be entered in response to prompts at various fields and drop down menus on the website. The identification information, description, and image(s) are preferably inputted at the delivery vehicle when the delivery vehicle arrives at the delivery location so as to accurately reflect the load conditions at the time of delivery.

At block 116, the identification information, description, and image(s) are stored on a database. More specifically, the database is configured to receive and store the identification information, description, and image from the control circuit. In one form, it is contemplated that that the database is remote from the mobile device and is coupled to a website server.

At block 118, the information regarding the load conditions (including the load description and image(s)) are used to generate feedback. For example, the information may be transmitted to the merchandise distribution center that shipped the merchandise to the shopping facility in order to address the loading of future deliveries from the distribution center. Also, the information may be transmitted to a manager or other individuals at the shopping facility. In another form, the information could be communicated to the delivery personnel or to an independent delivery service provider making the deliveries. This feedback information may include unstable pallet issues, unsafely stacked cases, pallet location issues, fallen loads, number of pallets, damaged cases, perishable merchandise temperature issues, the delivery route, and how the delivery vehicle was driven.

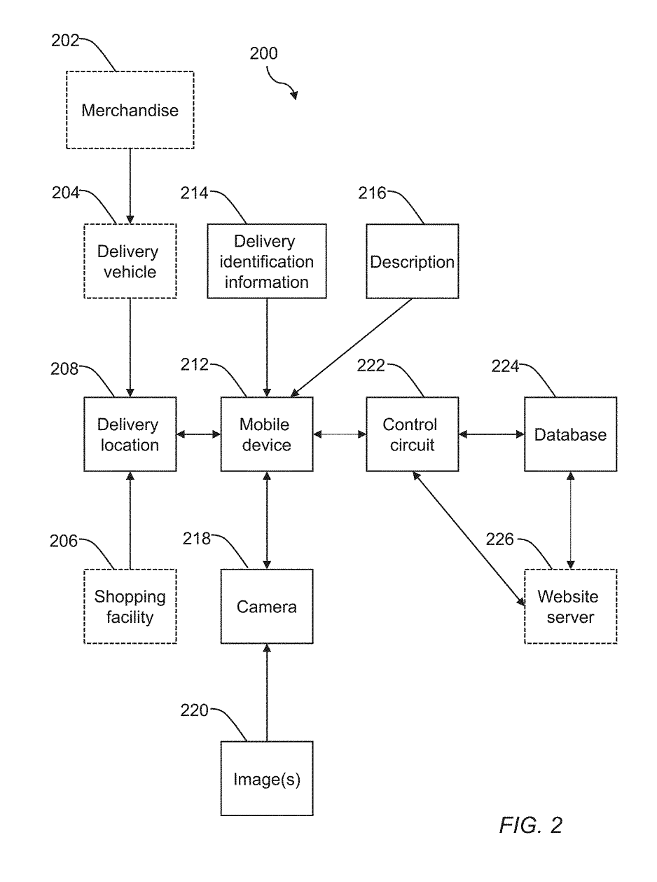

Referring to FIG. 2, there is shown a block diagram illustrating components of a system 200, As addressed below, the system 200 includes a mobile device that collects information regarding load quality and conditions on a delivery vehicle arriving at a delivery location, including delivery identification information, a description of the load conditions, and image(s) of the interior of the delivery vehicle. Users may submit real-time feedback of load conditions on mobile devices through forms and images. This information is communicated to a database where it may be used to provide feedback and correct potential poor load conditions in future deliveries.

As can be seen from FIG. 2, merchandise 202 is loaded onto a delivery vehicle 204. In one form, it is contemplated that the merchandise 202 is loaded onto the delivery vehicle 204 at a distribution center (which serves as the source for the delivery) and is then transported to a shopping facility 206 (which serves as the destination for the delivery). More specifically, the merchandise is transported to a delivery location 208 (such as a loading dock) at the shopping facility 206.

It is generally contemplated that different types of merchandise 202 may be transported that are subject to different loading procedures. For example, depending on the weight of a certain type of merchandise 202, the merchandise 202 may be preferably stacked on a specific type of pallet suitable for the total weight of the stacked merchandise 202. As another example, certain perishable merchandise 202 may have to be loaded at a location that is remote from other forms of merchandise.

After the delivery vehicle 204 arrives at the delivery location 208, the merchandise 202 and loading conditions are inspected by an individual/user (such as an employee at the shopping facility 206). The user conducts the inspection and memorializes the loading conditions at the time of the delivery using a mobile device 212. It is contemplated that any of various types of mobile devices may be used, such as smartphones and other portable computing devices (including MC40 handheld devices, tablets, and laptops).

In one form, during the inspection at the delivery location 208, the user may input three types of information using the mobile device 212. First, the user may input delivery identification information 214. For example, it is generally contemplated that the user preferably inputs a unique number or code identifier corresponding to the specific route (corresponding to date and/or time) of the delivery vehicle 204. Each delivery may therefore have a specific, unique number or code. As another example, however, it may be desirable to simply track deliveries by the source (such as a distribution center) or by the destination (such as the shopping facility). In other words, it may be sufficient to track the cumulative load conditions and quality shipped by a source or received at a destination (without the need for the detailed tracking of each individual delivery).

Second, the user may input a load condition description 216 of the delivery vehicle 204. For example, the user may describe merchandise 202 that was stacked improperly and that has tipped over during transport or that was stacked in a manner blocking the door of the delivery vehicle 204. As another example, the user may describe merchandise 202 that has not been packed properly, such as eggs being broken due to poor packing. Other examples include collapsed pallets (or other pallet information), damaged merchandise, or temperature that is not within the appropriate temperature range (such as perishable items not being suitably chilled).

Third, the user may utilize a camera 218 or other optical device to collect images 220 of the interior of the delivery vehicle 204. In one form, it is contemplated that the camera 218 is an integrated part of the mobile device 212, i.e., the mobile device 212 has a built-in camera 218. However, in another form, it is possible that the camera 218 may be a discrete device (a separate mobile device) that is not part of the mobile device 212. The camera 218 may be utilized to take still images or video of the interior of the delivery vehicle 204. As should be evident, the image(s) 220 provide a very accurate record of the load quality and conditions at the time of delivery.

The mobile device 212 is operatively coupled to a control circuit 222, which is configured to transmit the identification information, description, and image. It is generally contemplated that the control circuit 222 is an integrated part of the mobile device 212, although this integration is not required. The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 222 may be configured (for example, by using corresponding programming stored in a memory as will be well understood by those skilled in the art) to carry out one or more of the steps, actions, and/or functions described herein.

In one form, the control circuit 222 may store the delivery identification information 214, load condition description 216, and image(s) 220 in a database 224. For example, the mobile device 212, control circuit 222, and database 224 may form part of one unitary structural body. In this example, the delivery identification information 214, load condition description 216, and image(s) 220 may be stored locally in the mobile device 212. This information may then be downloaded or otherwise transmitted from the database 224 after the inspection is concluded and the user has left the delivery vehicle 204.

However, in another form, the control circuit 222 may be in wireless communication with a website server 226, or central computing device, which may enable access to and communication with a database 224, which is remote from the mobile device 212. For example, as described above, the website may utilize a customized form in which various fields may be populated and/or drop down menus may be used to input the delivery identification information 214 and the load condition description 216. Further, the website may facilitate attachment of the image(s) 220 of the interior of the delivery vehicle 204. This information may then be transmitted as feedback to other individuals and groups and appropriate action may be taken to seek to address and improve the load conditions.

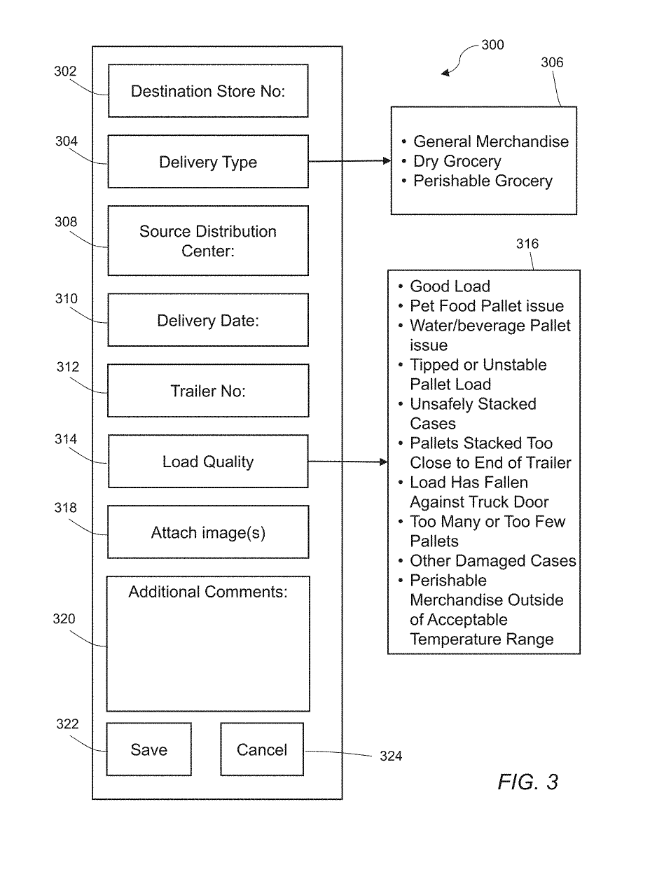

An example of a user-inputted customized feedback form 300 is shown in FIG. 3. As can be seen, the form 300 includes a number of fields that may require the entry of text from a user or may require drop down menus with specific entries for selection by the user. This is just one example of a form with examples of some of the fields, but of course, many other possible forms and fields are possible. In one embodiment, it is contemplated that the user may access an application that has been downloaded onto his mobile device. This downloaded application allows the user to access a website displaying the customized form 300 and allows the user to input the information in the fields of the customized form 300.

As can be seen in FIG. 3, the customized feedback form 300 includes several fields that are directed to identifying the delivery and various items relating to the delivery. More specifically, this particular form 300 includes a destination store field 302, a delivery type field 304, a source distribution center 308 field, a delivery date field 310, and a trailer number field 312. The user may enter text providing this identification information in fields 302, 306, 308, and 312. This information can be used to identify load condition issues for this particular delivery. It also may be used to track load condition trends over time across a number of deliveries, such as from a particular distribution center or to a particular store.

The customized feedback form 300 also includes a drop down menu 306 for the delivery type field 304. In this example, this menu 306 identifies three specific delivery types for selection by the user. As should be evident, different types of load condition issues may arise for different types of merchandise being delivered. This delivery type information may be also used to change some of the options and fields in the remainder of the form. For example, an indication of delivery type (perishable grocery) may lead to different drop down menus (such as route number or potential cross-contamination issues). Again, this delivery type information may be used to identify load quality issues for a particular delivery but also to identify trends relating to load quality issues for a specific delivery type arising over the course of numerous deliveries.

As can be seen in FIG. 3, the customized form 300 includes several fields identifying specific load condition issues for the delivery. More specifically, this specific example includes a load quality field 314, a field for the attachment of image(s) 318, and a field for additional comments 320. The load quality field 314 has a drop down menu 316 from which the user may select some of the most common load quality issues, such as: merchandise type pallet issues, unstable pallet issues, unsafely stacked cases, pallet location issues, fallen loads, number of pallets, damaged cases, and perishable merchandise temperature issues. The form 300 includes an attach image field 318 where the user may attach/embed one or more images of the interior of the delivery field that have been captured by the user. These images obviously accurately memorialize the load conditions at the time of delivery and provide a very accurate record of these conditions. The form 300 may include an additional comments field 320 where the user may elaborate on load quality conditions that have been identified or may identify any other load quality conditions not shown in drop down menu 316. The form 300 may also include an overall load rating within a numerical range (not shown). The form 300 includes buttons 322, 324 for saving and canceling the form 300. Once the form 300 is saved, it may also be transmitted to affected groups and individuals, as addressed below.

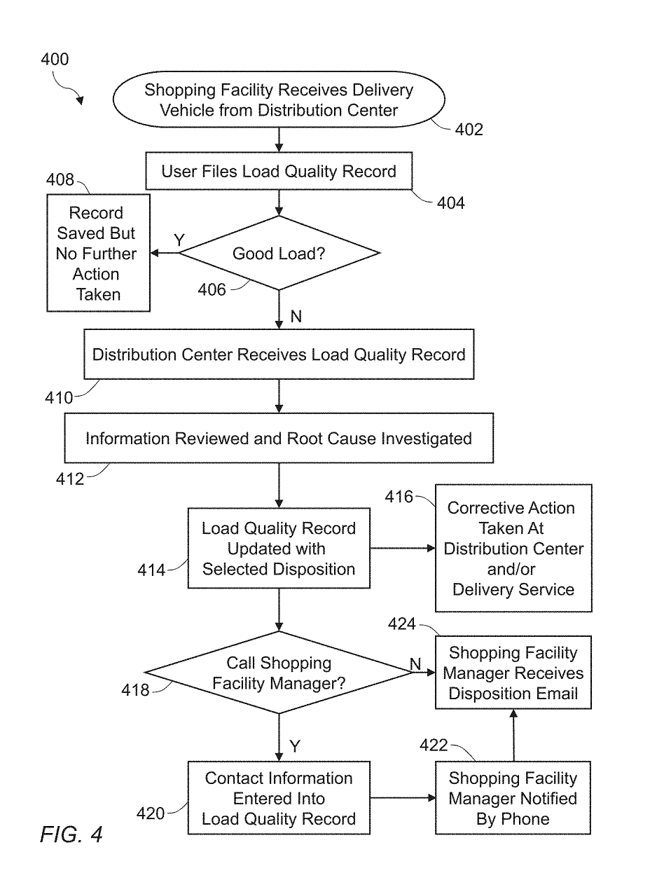

FIG. 4 shows an example of a process 400 for internal handling of a load quality feedback record generated by an inspection of a delivery vehicle. The load quality record is used to document and record logistic load quality feedback from a shopping facility to a distribution center. As shown at block 402, a delivery vehicle arrives at a shopping facility from a distribution center. Further, as shown at block 404, a user with a mobile device inspects the merchandise loaded in the delivery vehicle and files a load quality record. It is generally contemplated that these steps are accomplished in accordance with the processes and systems outlined above.

At block 406, a determination is made as to whether the loading of the merchandise on the delivery vehicle constituted a “good load.” This determination may be made solely by the user conducting the inspection at the delivery vehicle. It is also contemplated that this determination may be possibly made solely by a centralized quality control group or individual after reviewing the load quality record submitted by the user. Alternatively, this determination may be made based on some combination of inputs from the user and from the quality control group or individual.

As shown at block 408, if the determination is a “good load,” the quality control record may be saved but no further action need be taken. Alternatively, positive feedback may be provided to responsible groups and individuals. This record may be included in a database as a portion of the overall data that may be evaluated for any trends of load quality over time. For example, these trends may focus on load quality over time involving specific distribution centers, shopping facilities, delivery routes and services, merchandise delivery types, and other factors.

At block 410, a determination has been made that the delivery was not a “good load,” and the source distribution center receives the load quality record for further evaluation. The distribution center may retrieve the feedback electronically, and in fact, load quality information may be centralized, disseminated, and evaluated across multiple networks and recipients. At block 412, the information in the load quality record is reviewed and the root cause of any load quality issues is investigated. For example, an individual or group responsible for the distribution center operations and/or shipping may be tasked with the investigation.

As shown at block 414, once the investigation is completed, the load quality record may be updated with a selected disposition. For example, the customized form 300 may include an additional feedback field that is accessible to the investigating group or individual. Alternatively, this feedback field may be generated after filing of the load quality record. This field or fields may be in a format allowing for the entry of text and/or in a drop down menu format indicating various pre-approved possible disposition options.

At block 416, the selected disposition may be forwarded to or communicated to responsible individuals within the distribution center and/or delivery service so as to lead to any appropriate corrective action. For example, depending on the nature of the conditions identified in the load quality record, training procedures may need to be reviewed, modified, or reinforced, such as appropriate stacking and arrangement and use of pallets, how pallets are built, and load securement. Further, this corrective action may focus on other packing and arrangement issues, such as the use of shrink wrap, load locks, and air pillows. As additional examples, the corrective action may relate to the specific delivery routes driven, how the delivery vehicle was driven, and the functioning of cooling mechanisms within specific delivery vehicles. Generally, the corrective action may relate to any factor involving how the merchandise was loaded and how it might be subject to damage during transport.

At block 418, a decision is made as to whether the selected disposition warrants a phone call and feedback discussion with the shopping facility manager or responsible individual. For example, a representative at the distribution center may want to discuss the load quality conditions in order to potentially address what (if any) corrective action is being taken for future deliveries. If yes, contact information for the shopping facility manager may be entered into the load quality record (block 420), and the shopping facility manager may be contacted by phone (block 422). At block 424, the shopping facility manager may receive the written record of the disposition by email (regardless of whether the selected disposition warranted a phone call).

FIGS. 5-12 show screenshots of a dashboard and analytical approach to using the load quality reports (such as generated above) to determine issues for specific delivery vehicles/routes, specific shopping facilities, and specific geographical areas. This approach may provide executive visibility and analytics using the data from the load quality reports. For example, this approach may perform the following: track and report the number of load quality reports from stores (and the particular load quality issues therein); track the number of loads and the type of load quality issues (good or bad); provide heat maps of the geographic locations of load quality reports (and particular load quality issues therein); provide reporting to different executive levels of the company; provide detail reporting such as links to pictures from stores; and report the number of late deliveries.

FIGS. 5A and 5B show a first example of a dashboard 500 displaying some of this information. As can be seen, the United States has generally been divided into eastern and western portions. At bar chart 502, specific load quality issues are identified, and the number of reports identifying each of these issues is shown. These load quality categories were described above and may, for example, include the following: a good load, a tipped or unstable pallet, an improperly stacked container, a pallet near an end of a delivery vehicle, a load against a door of a delivery vehicle, late delivery, a delivery vehicle making multiple deliveries, or cross-contamination of merchandise. This chart 502 provides good feedback as to the most common issues with respect to load quality/condition and whether those issues are more prevalent in the eastern or western parts of the country.

In one form, some or all of the deliveries may be made from merchandise distribution centers to shopping facilities. At bar chart 504, the type of distribution center issue or corrective action (disposition) is identified, including, for example, associates/employees acting outside of standard operating procedures (requiring employee training), an open status requiring a response, a distribution center process requiring modification or revision, no load quality issue, a driver or route issue that needs to be addressed, securement or hardware relating to the loading, or packaging relating to the loading. The dashboard 500 also includes heat maps 506 showing the location of load quality issues and the location of late deliveries. It further shows load quality entries by store 508.

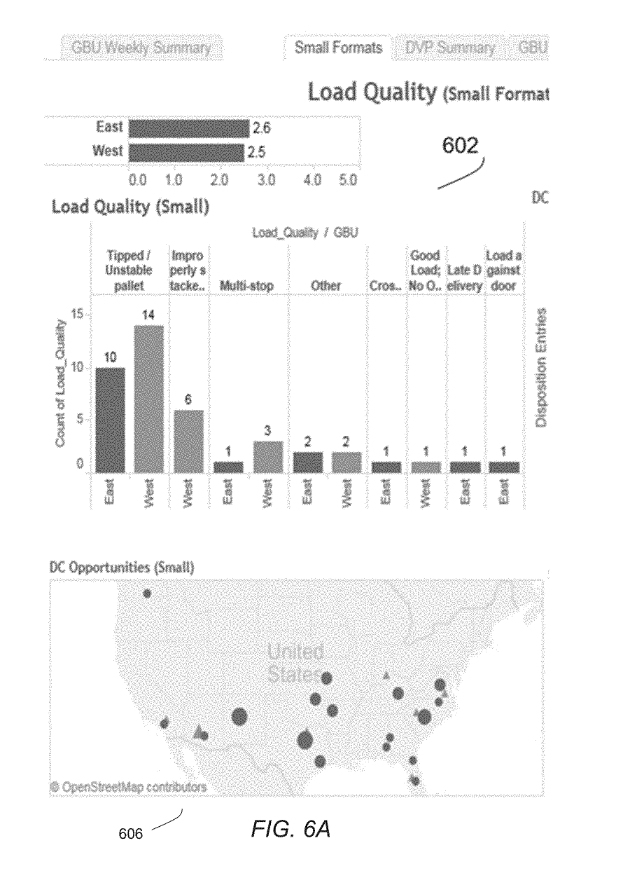

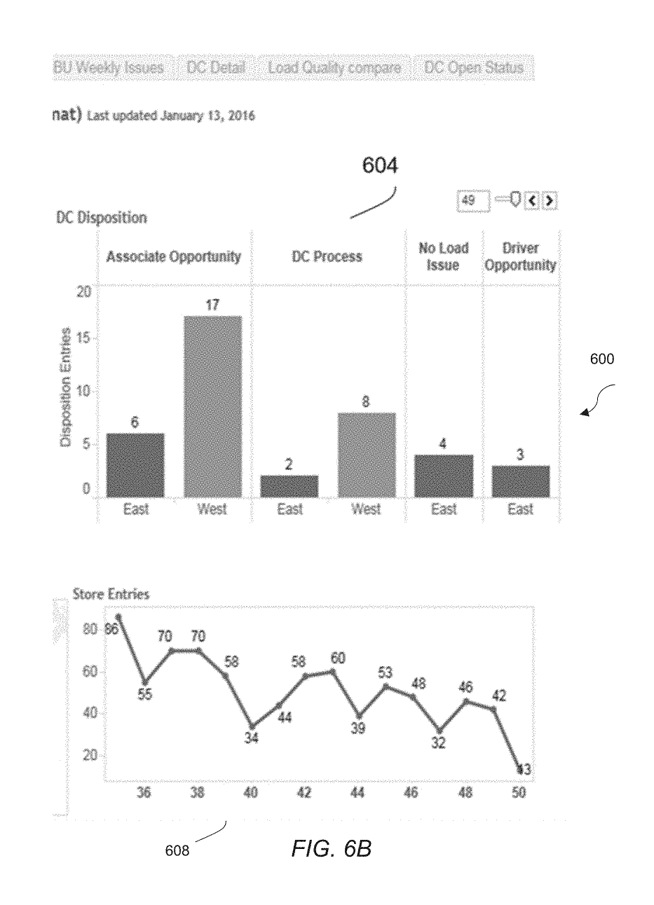

FIGS. 6A and 6B show a second example of a dashboard 600 that is similar to the dashboard 500 of FIGS. 5A and 5B but is directed to “small” stores. These “small” stores are generally neighborhood market locations and are generally smaller in physical size, i.e., have a square footage below a certain threshold. These “small” stores may be mainly focused on food (not other merchandise), and so, it has been determined that different sorts of load quality issues may be prevalent at these stores. For example, the load quality issues generally include more food-related issues, such as potential cross contamination and multi-stop issues where a delivery vehicles delivers the wrong product to the store. Further, there is more use of shrink wrapping in loading, so improper stacking or tipped pallets are not as common issues. FIGS. 6A and 6B show a bar chart 602 showing frequency of certain load quality issues, a bar chart 604 showing the type of distribution center issue or corrective action, a heat map 606 of load quality issues, and a graph 608 of store entries.

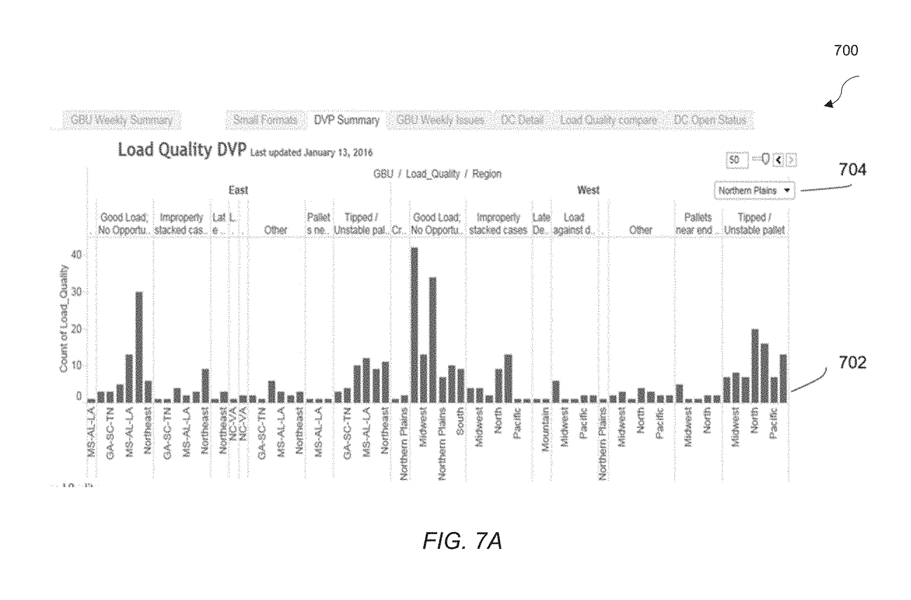

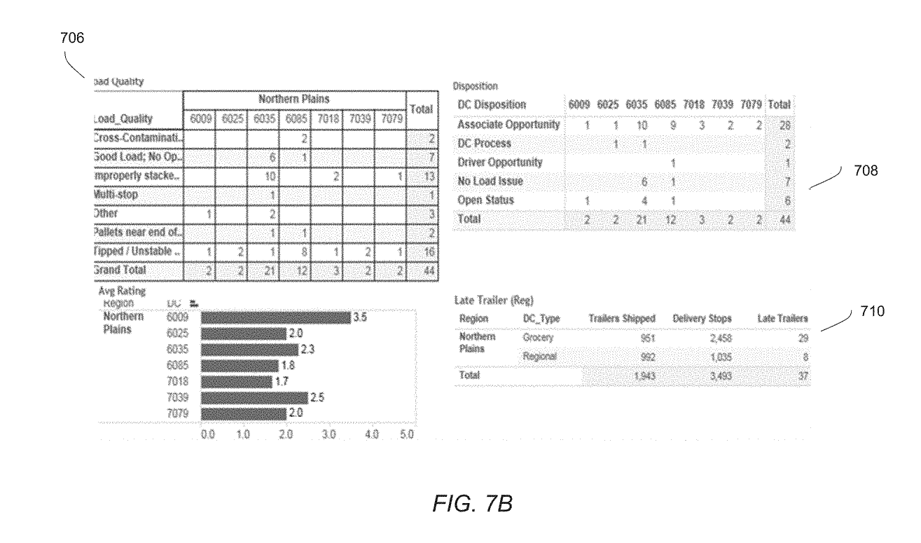

FIGS. 7A and 7B show a third example of a dashboard 700. The graph 702 shows various regions of the country and particular load quality issues for the different regions. This separation of load quality issues into the different regions helps identify load quality issues that appear more prevalent in certain regions. In this form, a drop down button 704 at the top right of FIG. 7A allows the user to toggle between different regions, and as can be seen, “Northern Plains” has been selected in this example. FIG. 7B includes a load quality table 706 showing the frequency of specific load quality issues/conditions in the Northern Plains and a distribution center disposition/handling table 708 showing the nature of the issue and required corrective action. It also includes a late delivery chart 710 for the Northern Plains.

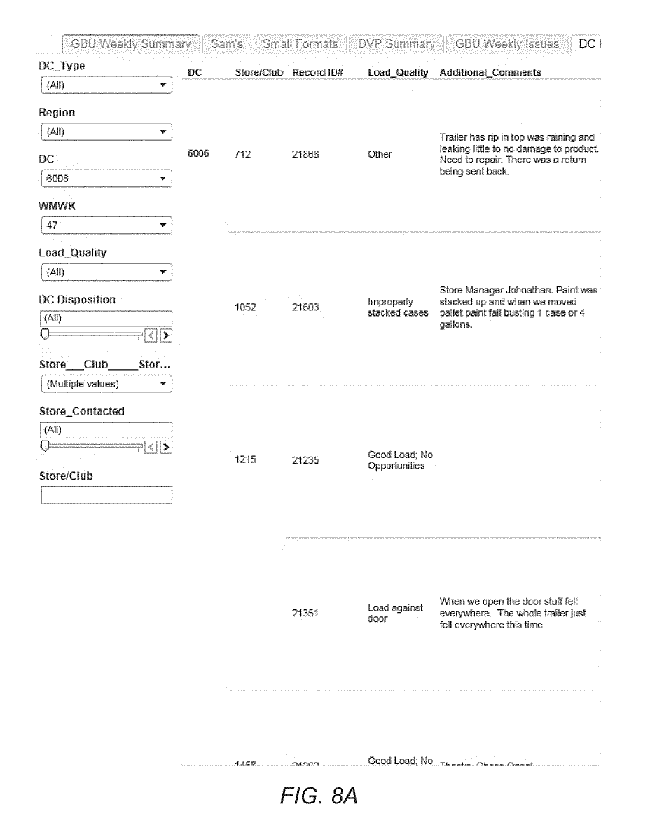

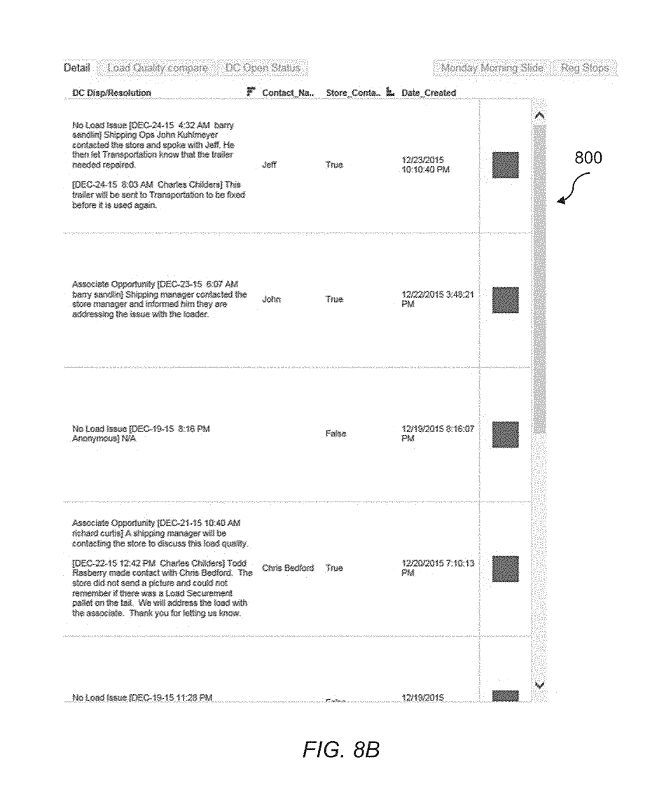

FIGS. 8A and 8B show a fourth example of a dashboard 800 that allows the user to obtain additional detail for specific load quality issues. This additional detail is the specific information from the store in each load quality report. The user can filter using various factors, such as distribution center type, region, a particular distribution center, specific load quality issues, etc. Here, the user has filtered by distribution center to view all of the load quality issues associated with a particular distribution center. In one form, the user can move a cursor to hover over (or click on) the squares at the right end of FIG. 8B to get extra detail, such as the image(s) captured in each load quality report and submitted to the store.

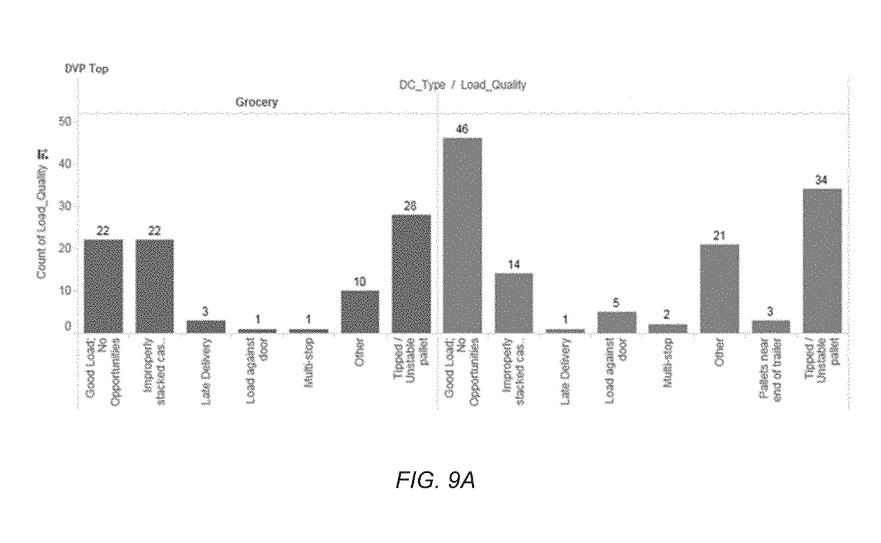

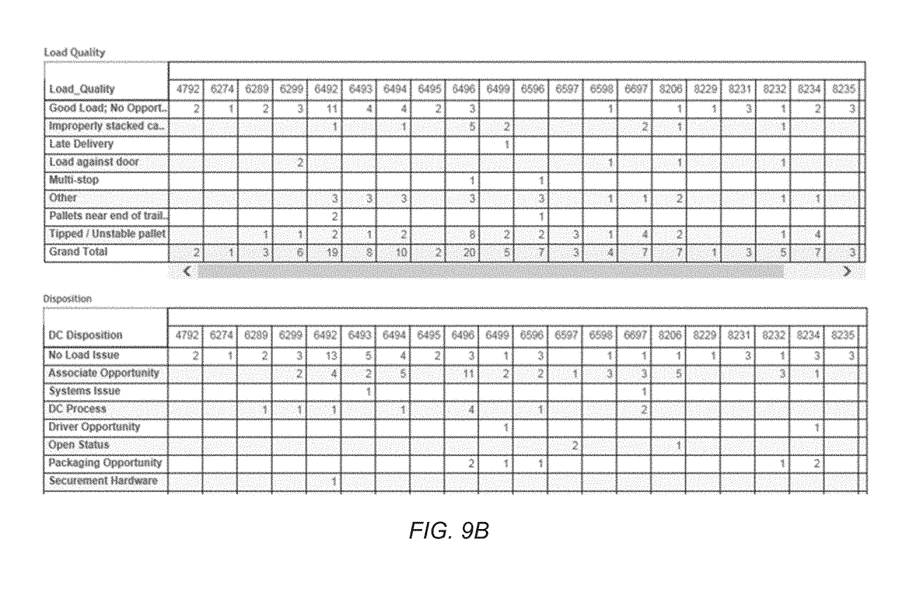

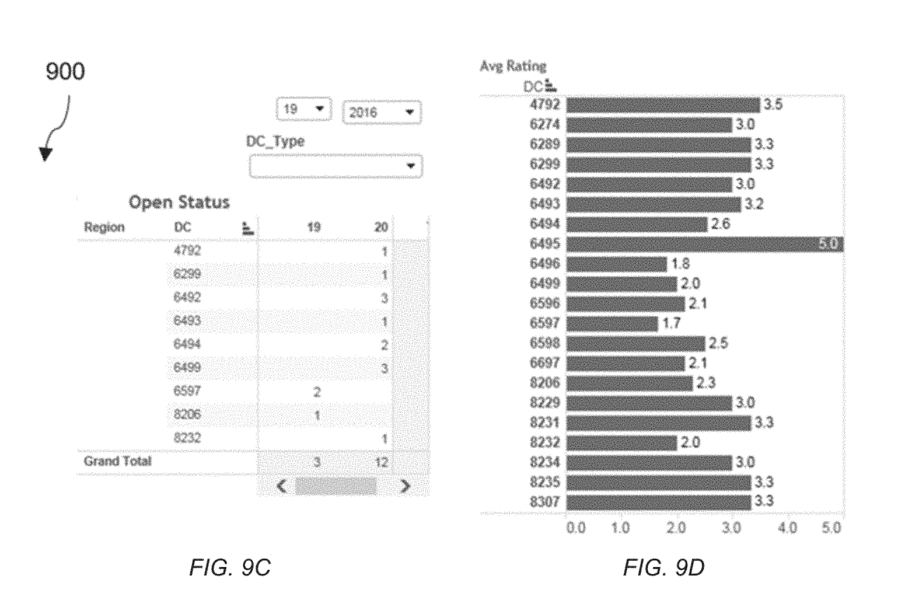

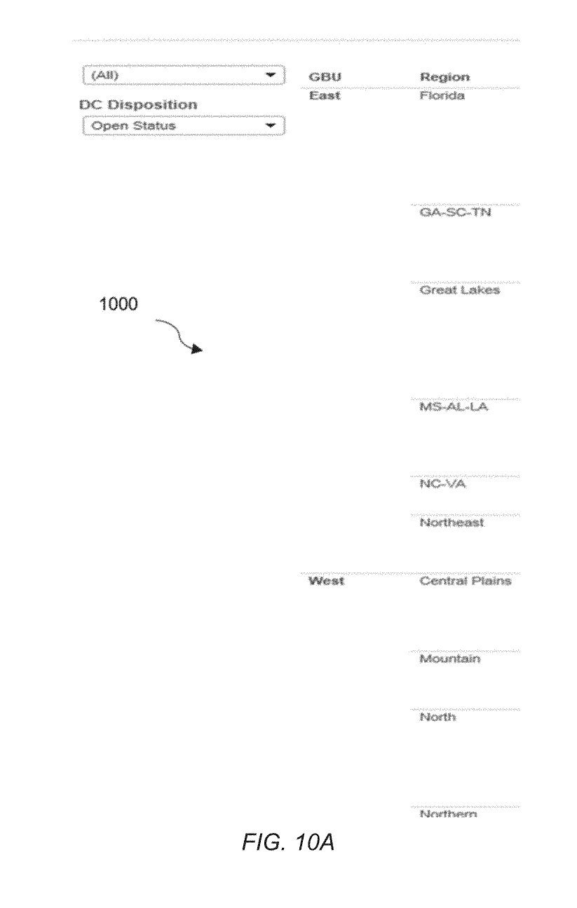

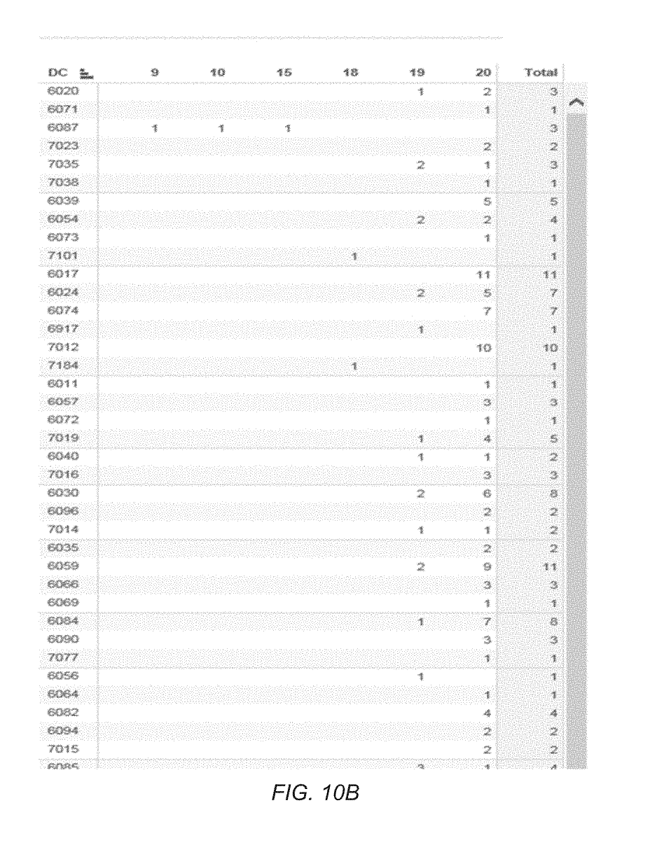

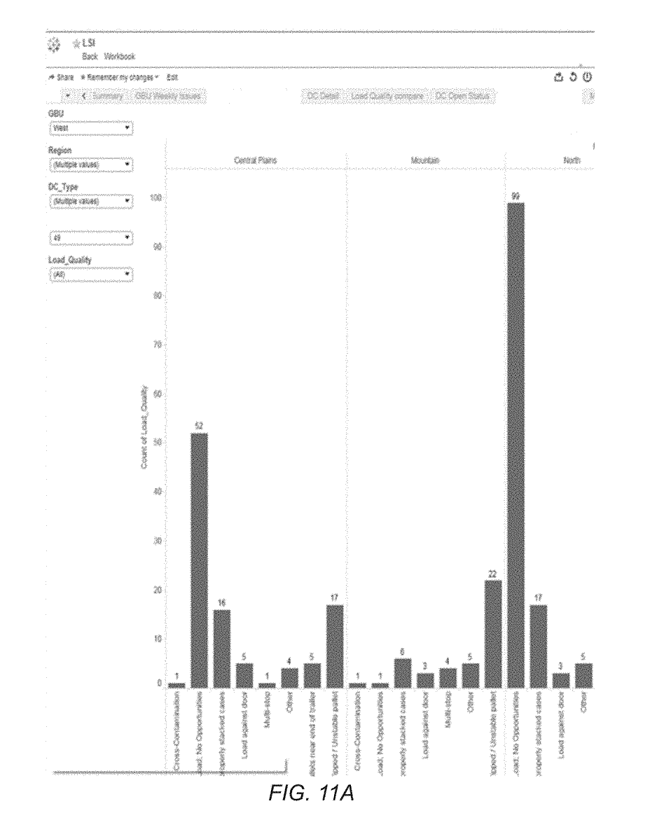

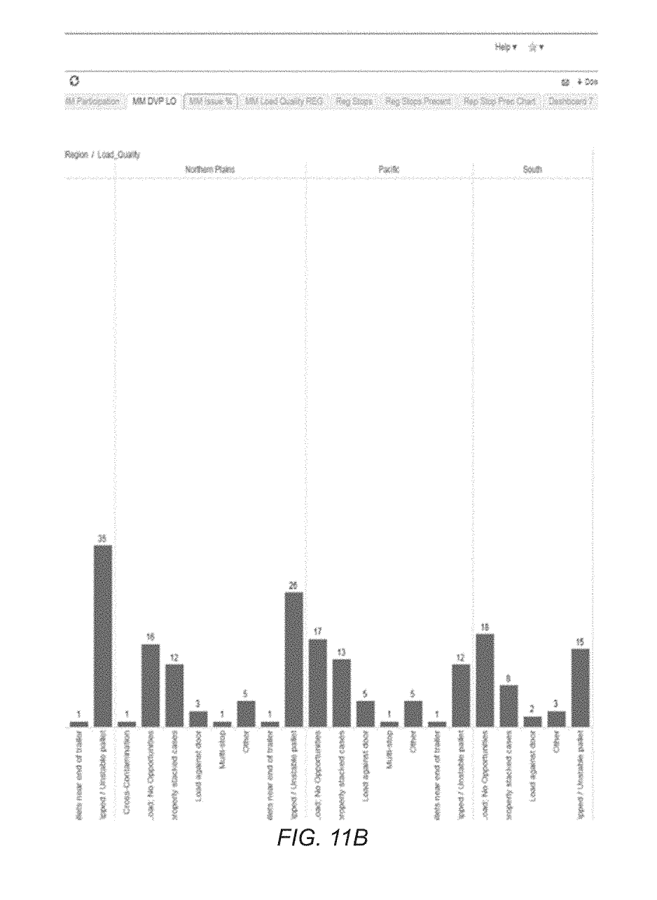

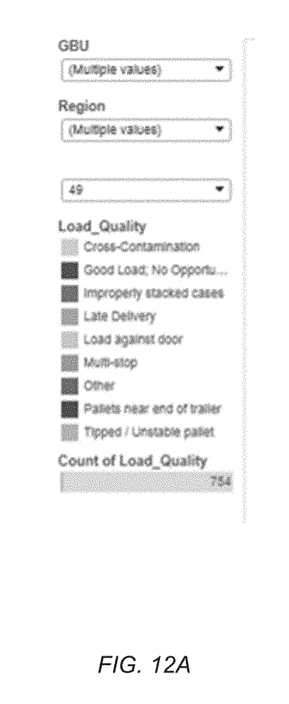

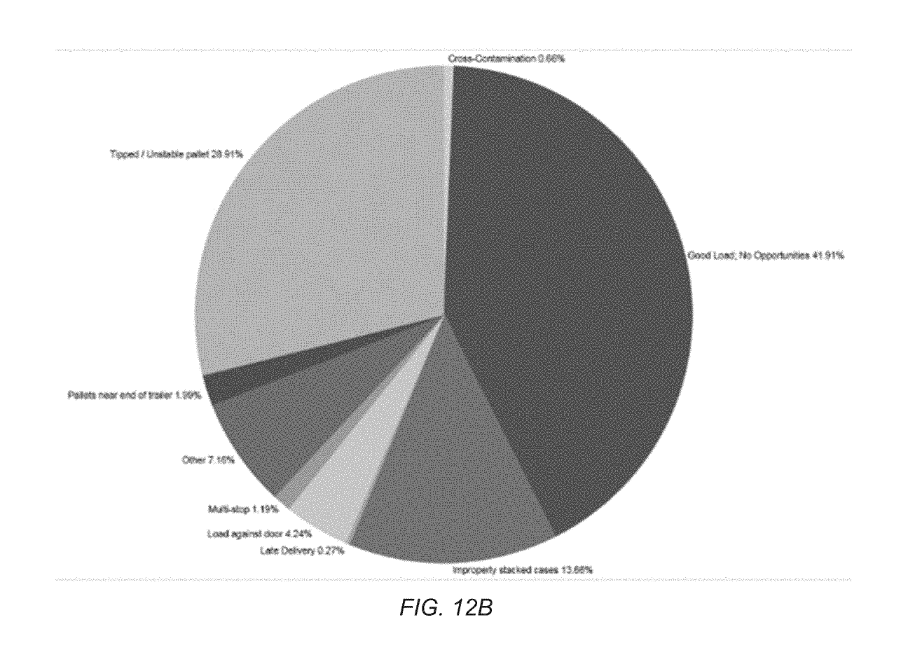

FIGS. 9-12 show additional examples of dashboards with an arrangement of information from the load quality reports. FIGS. 9A-D show, in part, a bar chart of the frequency of certain load quality issues and tables of load quality issues for and disposition by certain distribution centers. FIGS. 10A and 10B show the open status of load quality issues at specific distribution centers. FIGS. 11A and 11B show a bar chart of certain load quality issues arising in different geographic regions. FIGS. 12A and 12B illustrate a pie chart showing the proportion of load quality issues, which may be filtered by distribution center, shopping facility, geographic region, etc.

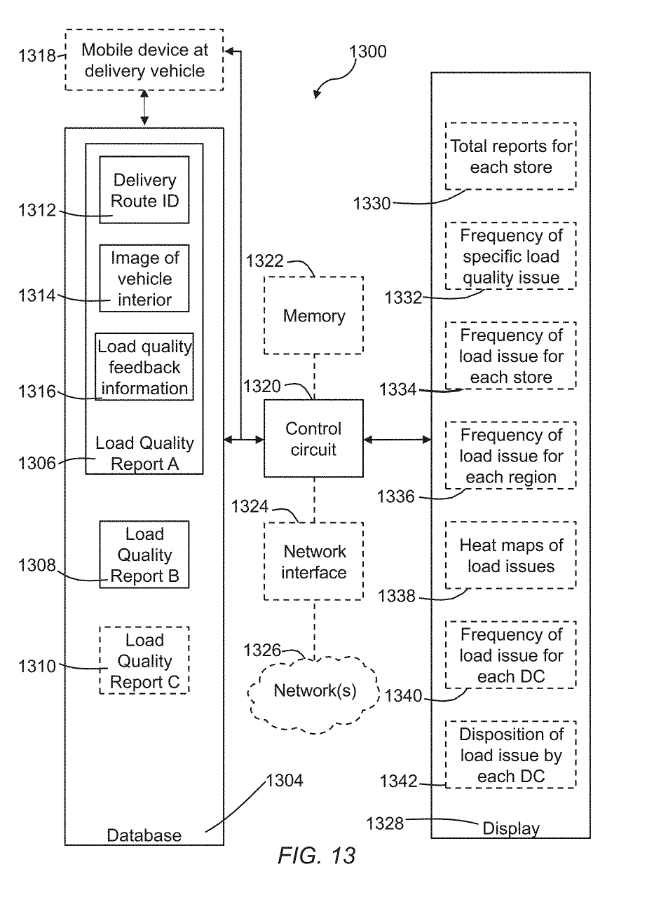

Referring to FIG. 13, there is shown a system 1300 for using the load quality reports generated for each delivery from a distribution center (DC) to a shopping facility. More specifically, the system 1300 analyzes the population of load quality reports to determine load quality issues/conditions that may arise for specific delivery vehicles/routes, distribution centers, shopping facilities, and geographical areas. This system 1300 allows users to quickly identify and possibly address the most common load quality issues that appear to arise in different circumstances.

The system 1300 includes a database 1304 that receives and stores the load quality reports created at the time of each delivery. As described above, each load quality report corresponds to the transport of merchandise by a delivery vehicle to a shopping facility. FIG. 13 specifically shows three load quality reports in the database 1304 (Load Quality Report A (1306), Load Quality Report B (1308), Load Quality Report C (1310)), but it should be evident that the database 1304 will likely include many more load quality reports (so as to provide meaningful data for the system 1300). Further, it is generally contemplated that at least one load quality report includes delivery route identification information 1312; an image 1314 of the interior of the delivery vehicle showing the loading and arrangement of merchandise; and load quality feedback information 1316 identifying at least one load quality issue/condition from a plurality of predetermined categories. In one form, it is contemplated that each load quality report will include this information. In addition, as described above, a mobile device 1318 may be used at each delivery vehicle at the time of delivery to collect, input, and transmit this information in real time, such as on the user-inputted customized feedback form 300 shown in FIG. 3. For example, an individual may use his or her mobile device 1318 to input the delivery route information 1312, to capture an image 1314, and to input load quality feedback information 1316 by selecting load quality issues from a drop down menu.

The system 1300 also includes a control circuit 1320 that is coupled to the database 1304 and that generally controls the operation of the system 1300. Being a “circuit,” the control circuit 1320 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings. The term “control circuit’ is generally given the same meaning as ascribed to control circuit 222 described above.

Such a control circuit 1320 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1320 is configured (for example, by using corresponding programming as will be well understood by those skilled in the art) to carry out one or more of the steps, actions, and/or functions described herein.

By one optional approach, the control circuit 1320 operably couples to a memory 1322. This memory 1322 may be integral to the control circuit 1320 or can be physically discrete (in whole or in part) from the control circuit 1320, as desired. This memory 1322 can also be local with respect to the control circuit 1320 (where, for example, both share a common circuit board, chassis, power supply, and/or housing) or can be partially or wholly remote with respect to the control circuit 1320 (where, for example, the memory 1322 is physically located in another facility, metropolitan area, or even country as compared to the control circuit 1320).

This memory 1322 can serve, for example, to non-transitorily store the computer instructions that, when executed by the control circuit 1320, cause the control circuit 1320 to behave as described herein. As used herein, this reference to “non-transitorily” will be understood to refer to a non-ephemeral state for the stored contents (and hence excludes when the stored contents merely constitute signals or waves), rather than volatility of the storage media itself, and hence includes both non-volatile memory (such as read-only memory (ROM)) as well as volatile memory (such as an erasable programmable read-only memory (EPROM).)

In this example, the control circuit 1320 also operably couples to a network interface 924. So configured, the control circuit 1320 can communicate with other elements (both within the system 900 and external thereto) via the network interface 924. Network interfaces, including both wireless and non-wireless platforms, are well understood in the art and require no particular elaboration here. This network interface 924 can compatibly communicate via whatever network or networks 926 may be appropriate to suit the particular needs of a given application setting. Both communication networks and network interfaces are well understood areas of prior art endeavor and therefore no further elaboration will be provided here in those regards for the sake of brevity.

The control circuit 1320 is in communication with one or more displays 1328 to show information derived from the load quality reports. For example, as shown in FIGS. 5-12, the control circuit 1320 may determine and display: the number of reports corresponding to deliveries to each shopping facility 1330, the number of reports identifying one particular load quality condition from the plurality of predetermined categories 1332, the number of reports identifying one particular load quality condition for deliveries to one particular shopping facility 1334, the number of reports identifying one particular load quality condition for deliveries to shopping facilities within a predetermined geographical area 1336, heat maps displaying load quality issues 1338 in various geographical regions, the number of reports identifying particular load quality issues corresponding to a distribution center 1340, and/or the disposition of load quality issues by distribution centers 1342.

Further, as described in FIGS. 8A and 8B, it is contemplated that the control circuit 1320 may be able to cause the display of the individual image(s) and load quality feedback information for each load quality report (e.g., by hovering over or clicking on the square at the right end of the display). Also, as previously described, each load quality report may include a description of the interior of the delivery vehicle (such as load condition description 216 described above and shown in FIG. 200), and this description may also be accessible in this manner. In other words, the load quality reports may include a description of how the merchandise delivered was loaded and arranged in the interior of the delivery vehicle. This description may include information regarding load stacking, load packing, arrangement and location of the load in the delivery vehicle, pallet information, damage to the load, and/or temperature information.

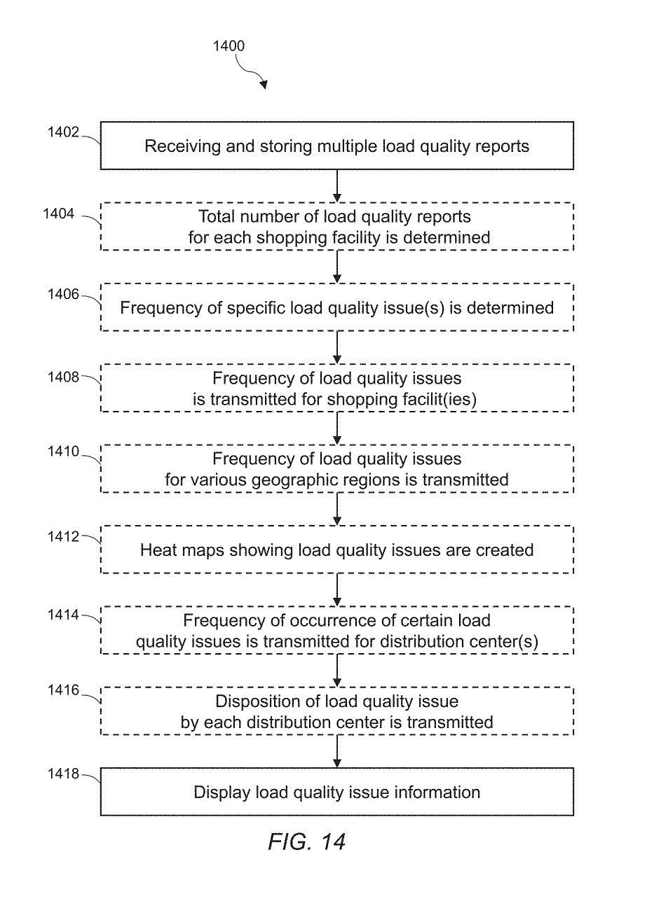

Referring to FIG. 14, there is shown a process 1400 for monitoring load quality issues of merchandise delivered by delivery vehicles to shopping facilities. In one form, it is contemplated that merchandise is delivered along a number of delivery routes between a first group of distribution centers and a second group of shopping facilities. It is further contemplated that load quality reports are generated for many of these deliveries, and these load quality reports may then be evaluated to determine various load quality issues/conditions in various circumstances and filtered by desired variables.

At block 1402, multiple load quality reports are received and stored. As indicated above, in one form, it is generally contemplated that an individual (such as shopping facility employee where a delivery is being made) may use a mobile device to access a website or software application. It is further contemplated that the individual may use the mobile device to input delivery route identification information, an image of the interior of the delivery vehicle showing the loading and arrangement of merchandise, and load quality feedback information identifying load quality condition(s) from various categories. In this manner, a number of load quality reports may be generated and transmitted showing load quality issues for many deliveries, and these reports may be received in a database.

The process 1400 further provides executive visibility and analytics for load quality data from these reports. For example, the process 1400 can track and report the total number of entries from stores and number of entries from each store (block 1404); the number of loads and the types and frequency of load quality issues (good or bad) (block 1406); the types and frequency of load quality issues for a specific shopping facility (block 1408); the types and frequency of load quality issues for different geographic regions of the country (block 1410); the types and frequency of load quality issues for a specific distribution center (block 1414); and the disposition of a load quality issue by a specific distribution center (block 1416). The process 1400 may also provide heat maps corresponding to where the load quality issues are being reported (e.g., area of the country) (block 1412). The process 1400 may include displaying this reporting (block 1418), such as to different executive/management levels of a retailer (distribution center managers, vice presidents, etc.). Optionally, the distribution center detailed reporting may include links to images of deliveries and other information from stores. Further, the process 1400 may optionally include late distribution reporting that may show the number of deliveries shipped and how many were late and may correlate to specific distribution centers and/or stores.

So, in some embodiments, there is provided a system comprising: a database configured to receive and store a plurality of load quality reports, each report corresponding to transport of merchandise by a delivery vehicle to one of a plurality of predetermined shopping facilities; at least one load quality report c: delivery route identification information, an image of the interior of the delivery vehicle showing loading and arrangement of merchandise, and load quality feedback information identifying at least one load quality condition from a plurality of predetermined categories; a control circuit operatively coupled to the database, the control circuit configured to determine at least one of: the number of reports corresponding to deliveries to each shopping facility, the number of reports identifying one particular load quality condition from the plurality of predetermined categories, the number of reports identifying one particular load quality condition for deliveries to one particular shopping facility, and the number of reports identifying one particular load quality condition for deliveries to shopping facilities within a predetermined geographical area; and a display in communication with the control circuit and configured to show information determined by the control circuit.

Further implementations of these embodiments are provided. For example, in some implementations, the at least one load quality condition from a plurality of predetermined categories may comprise a good load, a tipped or unstable pallet, an improperly stacked container, a pallet near an end of a delivery vehicle, a load against a door of a delivery vehicle, late delivery, a delivery vehicle making multiple deliveries, or cross-contamination of merchandise. In some implementations, the display may be configured to show a heat map showing the geographical areas of shopping facilities reporting a particular load quality condition from the plurality of predetermined categories. In some implementations, the control circuit may be configured to determine the number of reports identifying a particular load quality condition for deliveries to shopping facilities with a square footage below a predetermined amount. In some implementations, the plurality of load quality reports may correspond to the transport of merchandise by delivery vehicles to a plurality of predetermined shopping facilities from a plurality of predetermined merchandise distribution centers. In some implementations, the control circuit may be configured to determine the number of reports identifying the load quality conditions for deliveries from a particular merchandise distribution center. In some implementations, the control circuit may be configured: to determine corrective action by a merchandise distribution center to address a particular load quality condition comprising at least one of employee training, revision of a merchandise distribution center process, and delivery vehicle driver or route feedback; and to display disposition of the load quality condition by the merchandise distribution center. In some implementations, the control circuit may be configured to display the image and load quality feedback information for the at least one load quality report. In some implementations, the at least one load quality report may be a real time report transmitted to the control circuit by a mobile device at a delivery vehicle at the time of a delivery. In some implementations, the at least one load quality report further may include a description of how delivered merchandise was loaded and arranged in the interior of the delivery vehicle. In some implementations, the description may comprise at least one of information regarding load stacking, load packing, arrangement and location of the load in the delivery vehicle, pallet information, damage to the load, and temperature information.

In some embodiments, there is provided a method for monitoring load quality of merchandise delivered to shopping facilities, the method comprising: receiving and storing a plurality of load quality reports in a database, each report corresponding to transport of merchandise by a delivery vehicle to one of a plurality of predetermined shopping facilities; at least one load quality report including: delivery route identification information, an image of the interior of the delivery vehicle showing loading and arrangement of merchandise, load quality feedback information identifying at least one load quality condition from a plurality of predetermined categories; by a control circuit, determining at least one of: the number of reports corresponding to deliveries to each shopping facility, the number of reports identifying one particular load quality condition from the plurality of predetermined categories, the number of reports identifying one particular load quality condition for deliveries to one particular shopping facility, and the number of reports identifying one particular load quality condition for deliveries to shopping facilities within a predetermined geographical area; and displaying information determined by the control circuit.

Further implementations of these embodiments are provided. For example, in some implementations, the at least one load quality condition from a plurality of predetermined categories may comprise a good load, a tipped or unstable pallet, an improperly stacked container, a pallet near an end of a delivery vehicle, a load against a door of a delivery vehicle, late delivery, a delivery vehicle making multiple deliveries, or cross-contamination of merchandise. In some implementations, the method may further comprise displaying a heat map showing the geographical areas of shopping facilities reporting a particular load quality condition from the plurality of predetermined categories. In some implementations, the control circuit may determine the number of reports identifying a particular load quality condition for deliveries to shopping facilities with a square footage below a predetermined amount. In some implementations, the plurality of load quality reports may correspond to the transport of merchandise by delivery vehicles to a plurality of predetermined shopping facilities from a plurality of predetermined merchandise distribution centers. In some implementations, the control circuit may determine the number of reports identifying the load quality conditions for deliveries from a particular merchandise distribution center. In some implementations, the control circuit may determine corrective action by a merchandise distribution center to address a particular load quality condition comprising at least one of employee training, revision of a merchandise distribution center process, and delivery vehicle driver or route feedback; and the method may comprise displaying disposition of the load quality condition by the merchandise distribution center. In some implementations, the method may further comprise displaying the image and load quality feedback information for the at least one load quality report. In some implementations, the at least one load quality report may be a real time report transmitted to the control circuit by a mobile device at a delivery vehicle at the time of a delivery.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for monitoring load quality of merchandise delivered to shopping facilities, the system comprising:
a delivery location at a shopping facility configured to receive a delivery vehicle;
a mobile device configured to:
input identification information regarding delivered merchandise transported in the delivery vehicle;
input a description of how delivered merchandise is loaded and arranged in the interior of the delivery vehicle;
capture and input an image of the interior of the delivery vehicle showing loading and arrangement of merchandise;
a control circuit operatively coupled to the mobile device and configured to transmit the identification information, description, and image; and
a database configured to receive and store the identification information, description, and image from the control circuit.

2. The system of claim 1, wherein the identification information comprises at least one of shopping facility identification, shipping source identification, route information, delivery vehicle identification, type of merchandise, and date of delivery.

3. The system of claim 1, wherein the description comprises at least one of information regarding load stacking, load packing, arrangement and location of the load in the delivery vehicle, pallet information, damage to the load, and temperature information.

4. The system of claim 1, wherein capturing an image comprises using a camera to take a picture or video of the interior of the delivery vehicle.

5. The system of claim 1, wherein the image conveys information regarding how the merchandise was loaded, transported, or found at the delivery location after delivery.

6. The system of claim 1, wherein the identification information, description, and image is inputted at the delivery vehicle when the delivery vehicle arrives at the delivery location.

7. The system of claim 1, wherein the control circuit is in wireless communication with a website server configured to serve as a platform for the input of the identification information, description, and image and to allow storage to the database coupled to the website server.

8. The system of claim 1, wherein the merchandise is delivered to the delivery location from a distribution center.

9. The system of claim 1, wherein the mobile device comprises a smartphone, a computer tablet, or a portable computer.

10. A method for monitoring load quality of merchandise delivered to shopping facilities, the method comprising:
by a mobile device, inputting identification information regarding delivered merchandise transported in a delivery vehicle to a shopping facility; and
by a mobile device, inputting a description of how delivered merchandise is loaded and arranged in the interior of the delivery vehicle; and
by a mobile device, capturing and inputting an image of the interior of the delivery vehicle showing loading and arrangement of merchandise.

11. The method of claim 10, wherein the identification information comprises at least one of shopping facility identification, shipping source identification, route information, delivery vehicle identification, type of merchandise, and date of delivery.

12. The method of claim 10, wherein the description comprises at least one of information regarding load stacking, load packing, arrangement and location of the load in the delivery vehicle, pallet information, damage to the load, and temperature information.

13. The method of claim 10, wherein capturing an image comprises using a camera to take a picture or video of the interior of the delivery vehicle.

14. The method of claim 10, further comprising storing the identification information, description, and image on a database.

15. The method of claim 14, further comprising wirelessly communicating with a website server configured to serve as a platform for the input of the identification information, description, and image and to allow storage to the database coupled to the website server.

16. The method of claim 10, further comprising transmitting feedback information regarding the description and image to a merchandise distribution center that shipped the merchandise to the shopping facility.

17. The method of claim 10, further comprising transmitting feedback information regarding the description and image to a manager at the shopping facility.

18. The method of claim 10, further comprising delivering the merchandise from a merchandise distribution center to a delivery location receiving the delivery vehicle at the shopping facility.
